(19) United States
(12) Patent Application Publication
(10) Pub. No.: US 2016/0366810 A1
(43) Pub. Date: Dec. 22, 2016

(54) FIELD CULTIVATOR BLADE INSTALLATION DEVICE

(71) Applicant: Daniel S. Helfrich, Smithton, IL (US)

(72) Inventor: Daniel S. Helfrich, Smithton, IL (US)

(21) Appl. No.: 15/185,717

(22) Filed: Jun. 17, 2016

Related U.S. Application Data
(60) Provisional application No. 62/180,825, filed on Jun. 17, 2015.

(51) Int. Cl. A01B 15/02; B25B 27/14

(52) U.S. Cl. CPC A01B 15/02; B25B 27/14

(57) ABSTRACT

A device to facilitate the installation of a cultivator blade on a shank. The device comprises a frame having a configuration complementary to the peripheral configuration of the blade and defining a channel that fits over the cultivator blade to seat at least a portion of the edges or wings of the blade as well as to protect the tip of the blade. The device has a fortified or reinforced tip to provide a striking surface. To use, the blade is seated in the device and positioned on the shank and the installer can strike the striking surface and the force of the blow is spread along the periphery of the blade to prevent or reduce damage to any one area of the blade.

### CROSS-REFERENCE TO RELATED APPLICATIONS

This application claims the benefit of provisional patent application Ser. No. 62/180,825, filed Jun. 17, 2015, which is incorporated herein by reference.

### BACKGROUND

A cultivator is any of several types of farm implements used for secondary tillage. In one aspect, the cultivator comprises a frame with teeth that pierce the soil as they are dragged through it. Cultivators stir and pulverize the soil, either before planting (to aerate the soil and prepare a smooth, loose seedbed) or after the crop has begun growing to kill weeds by uprooting them or burying their leaves to disrupt their photosynthesis, or a combination of both. Unlike a harrow, which can plow or dig up the entire surface of the soil, cultivators are designed to work the soil in careful patterns, sparing the crop plants but disrupting the weeds.

Cultivators of the toothed type are often similar in form to chisel plows, but their goals are different. Cultivator teeth work near the surface, usually for weed control, whereas chisel plow shanks work deep beneath the surface, breaking up hardpan. Consequently, cultivating also takes much less power per shank than does chisel plowing. However, cultivators and chisel plows often use similarly configured teeth or blades.

Field cultivators are usually drawn as an attachment behind a tractor, especially row-crop tractors. Field cultivators can vary greatly in size and shape, from 10 feet to 80 feet wide. Generally speaking, the implement has many shanks mounted on the underside of a metal frame. In some aspects, the shanks terminate in replaceable blades. The blades are known by several different names including blades, points, teeth, sweeps and shoes. The blades cut weeds from the roots near the base of the crop and turn over soil, while two rear sweeps further outward than the center blades deal with the center of the row, and can be anywhere from 1 to 5 rows wide. The blades come in various configurations, however, most conventional blades are arrowhead shaped or pointed.

Typically, the blades are removably attached to the shanks, most often by retaining means such as a spring biased detent on the shank that engages a hole or opening in the base of the blade. The blades generally can be replaced or removed for sharpening or repair. It will be appreciated that to keep the blade in place during cultivation the attachment means must be heavy duty. Consequently, it can be difficult to actuate the detent mechanism, particularly if the implement is old, rusted, dirty or so forth. To remove a blade, the user can actuate the retaining means to disengage the blade from the shank. Often the user must strike the blade with a hammer or the like near the base to remove the blade from the shaft. If the blade is being replaced, this procedure works well since the user is not concerned about damage to the blade.

If the blade is being removed for repair or sharpening, or a new blade is being installed, the process of installing the blade can be difficult. Spring biased detents can be difficult to actuate due to wear, dirt, corrosion and so forth. Often the user must strike the new or repaired blade with a hammer or the like to install the blade. As can be appreciated, striking the blade, particularly on the point or wings can damage the blade.

It would be advantageous, therefore, to have a device to facilitate installation of a field cultivator blade on a shank without damaging the blade.

### SUMMARY

Accordingly, a device is provided which facilitates the installation of a cultivator blade on a shank. The device broadly disperses the impact of a strike or blow to install the blade onto the cultivator shank, thereby eliminating or substantially reducing damage to the blade. The device has a frame which has a peripheral configuration complementary to the peripheral configuration of the blade. The device defines a channel that fits over the cultivator blade to seat at least a portion of the edges or the wings of the blade as well as protect the tip of the blade. The device has a fortified or reinforced tip to provide a striking surface.

Also provided is a method of using the above-described device. A device as described herein is obtained. The blade is positioned on the shank, and the device is positioned over the blade, such that the installer can strike or otherwise impel the striking surface of the device to join the blade to the shank. In so doing, the force of the blow is spread along the periphery of the blade to prevent or reduce damage to any one area of the blade. The device or its tip's striking surface may be fashioned from steel, iron or other hard durable metal, or a hard durable plastic, rubber or other such protective material.

In a further aspect of the invention, a cultivator blade installation kit is provided. The kit includes a cultivator blade unattached to a cultivator shank and a device to facilitate the installation of the cultivator blade on the shank. The device includes a frame having a peripheral configuration complementary to the peripheral configuration of the cultivator blade. The frame of the device defines a channel that fits over at least a portion of the edges of the cultivator blade to seat the blade and a fortified or reinforced tip to provide a striking surface.

### BRIEF DESCRIPTION OF THE DRAWINGS

FIG. 1 is a front plan view of a representative prior art field cultivator;

FIG. 2 is a top perspective view of the device and a cultivator blade;

FIG. 3 is a top perspective view of a cultivator blade partially engaged in the device;

FIG. 4 is a bottom perspective view of a cultivator blade seated in the device; and

FIG. 5 is a cross-sectional view of one side of the device taken along line S-S of FIG. 3.

### DETAILED DESCRIPTION

The foregoing summary, as well as the following detailed description of certain embodiments will be better understood when read in conjunction with the appended drawings. As used herein, an element or step recited in the singular and preceded with the word “a” or “an” should be understood as not excluding the plural of said elements or steps, unless such exclusion is explicitly stated. Furthermore, references to “one embodiment”, “an embodiment” and such, are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments as described and shown herein provide a disclosed device, method and kit that are primarily intended to be used to install a field cultivator blade on the shank of a field cultivator. The blade also is known as including a point, a sweep, a tooth, or a shoe. Hereinafter the term blade will be used for simplicity and clarity. Also, one skilled in the art will recognize that the device may have other uses, without departing from the scope of the invention.

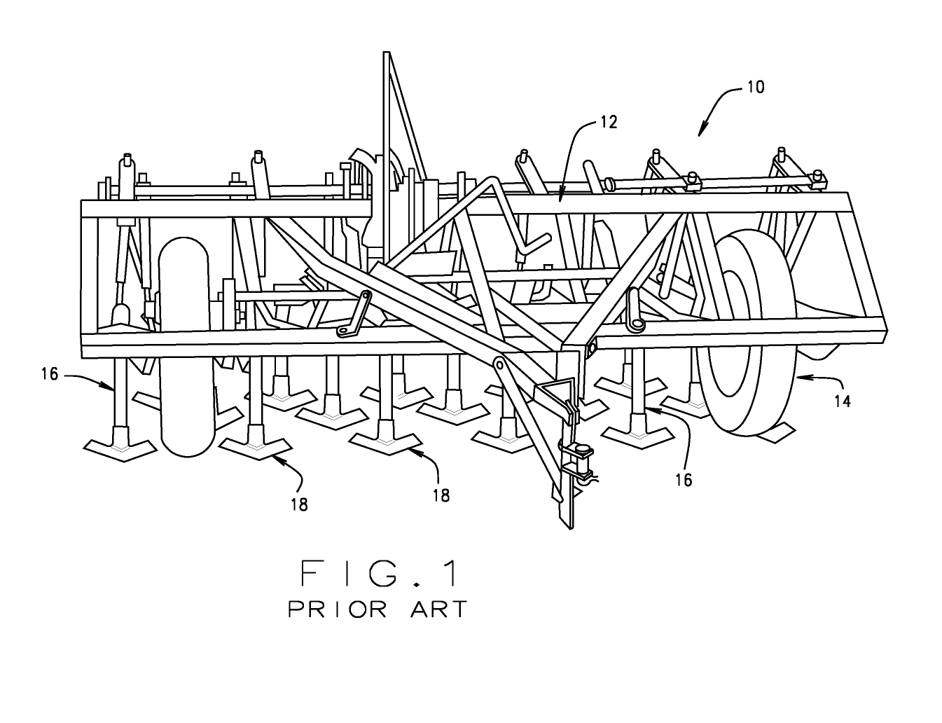

A representative embodiment of a prior art field cultivator is shown in FIG. 1 and indicated generally by reference number 10. Cultivator 10 comprises a frame 12 and wheels 14 and is intended to be pulled by a tractor or the like. As shown, cultivator 10 includes a plurality of downwardly depending shanks 16. Each shank 16 terminates in a blade 18. Shanks 16 generally are not absolutely rigid in that they have some flex or give if the blade hits an obstruction. It will be noted that each blade 18 is secured to the bottom end of a shank 16. As disclosed herein, a blade 18 is removably attached to a shank 16 as will be explained in reference to the disclosed device.

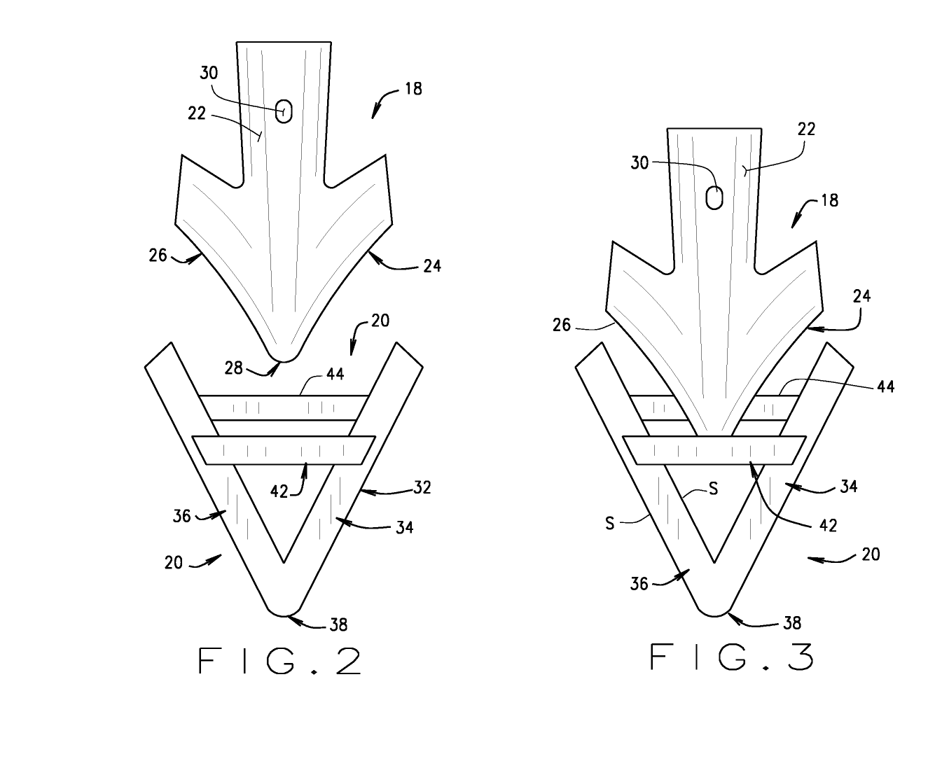

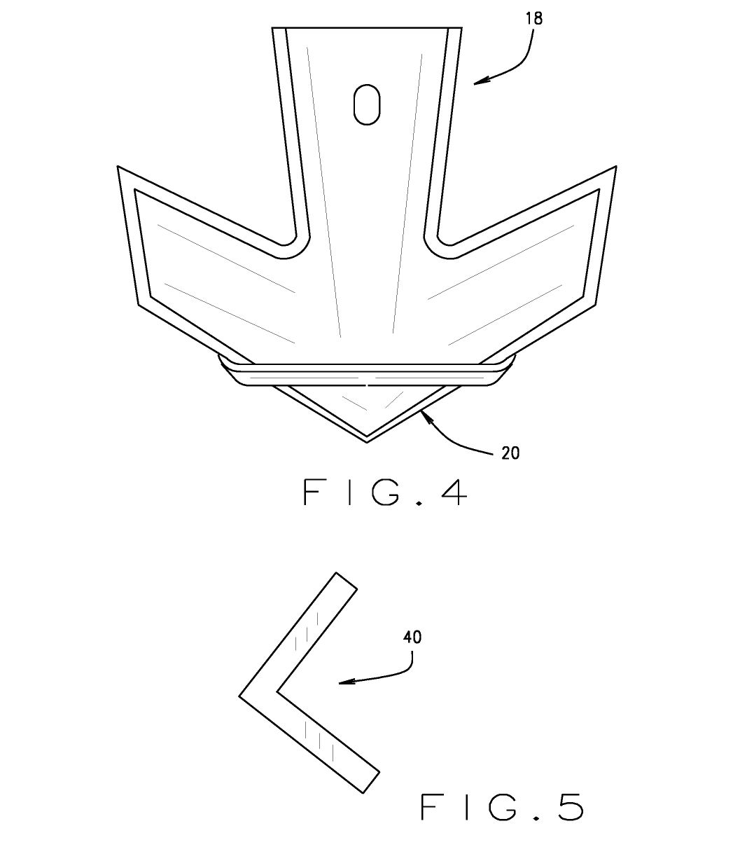

FIG. 2 shows a representative blade 18 adjacent the installation device, indicated generally by number 20. As shown, blade 18 has a general arrowhead configuration including a center base 22, a first or right wing 24, a second or left wing 26 and a tip or point 28. There is a hole or opening 30 in base 22 for attaching the blade to a shank. In one aspect, the shank includes a spring-biased detent. The detent can be compressed into the shank and the blade positioned over the end of the shank until the detent pops through opening 30 and is secured in place. To remove the blade, the detent is depressed and the blade is removed. For installation of a new, modified or reconditioned blade, e.g., the blade is positioned on the end of the shank and urged or forced upwardly until the detent pops through opening 30.

It will be understood that many times it is difficult to get the new blade secured on the shank. For example, the shank may be slightly deformed or the detent mechanism is worn, rusted or dirty and not easily depressed. In those cases, the installer will force the blade on the shank by striking the blade with a hammer or the like. Striking the blade with a hammer can deform or damage the blade, rendering it unsuitable for use.

Installation device 20 is employed to facilitate installation of blade 18 on a shank. As seen in the drawings, device 20 has an overall peripheral configuration complementary to the peripheral configuration of blade 18. More specifically, device 20 includes a V-shaped frame 32 having a first side 34, a second side 36 meeting at tip 38. In one preferred aspect, device 20 is fashioned from steel or iron or other hard, durable metal. It will be noted that tip 38 is fortified or reinforced, for example by hard welding or by providing a strike pad or other structure on the tip. The strike surface may be integral with, welded to, or otherwise firmly attached to the tip of the device to facilitate the ease with which the blade is urged onto the shank during installation.

As shown in FIG. 5, in various of such embodiments the respective sides of the installation device define an inner channel 40, e.g., having a generally V-shaped cross-section such that the device's inner channel 40 is configured to take in, or snugly fit around, the tip 28 and all or at least some portion of the edges or wing areas 24, 26, of the blade 18. There is a top, or first, brace 42 extending between the first and second sides and a bottom, or second, brace 44 extending between the first and second sides. As shown, in the depicted embodiment, top brace 42 is positioned closer to tip 38 so as to not extend across opening 30 when the blade is in the device. Furthermore, offset braces 42 and 44 provide substantial, or full, rigidity to the device and resist torque. Additionally, in particular embodiments, the braces are configured to permit the blade, or blade end to slide in between them to provide support for the blade during the installation process.

In use, according to this embodiment, a device 10 of the type described herein is obtained. The blade 18 is positioned within device 10 such that right wing 24 is seated in channel 40 of first side 34; wing 26 is seated in channel 40 of second side 36 and tip 28 is seated in tip 38 of device 20. Blade base 22 is positioned over the end of a shank 16 and urged upwardly on the shank so as to engage the detent in opening 30. If the installation meets with resistance or the detent does not depress, etc., the installer can strike the fortified or reinforced tip 38 (a strike surface) with a hammer or other instrument and drive the blade onto the shank until it is properly affixed. Because the leading edges or wings 24 and 26 and tip 28 are seated in channel 40, the energy of the hammer blows is broadly or evenly distributed along the leading edges of the blade. This prevents, or at least substantially reduces, damage to the cultivator blade(s) and also facilitates installation.

It is also envisioned that a cultivator blade, such as a new, replacement, repaired or resurfaced blade, and the above-described installation device will be combined as a kit. The kit may include the cultivator blade unattached to a cultivator shank and one of the embodiments of the above-described device designed to facilitate the installation of the cultivator blade on the shank. Other components, such as a blade sharpener, anti-corrosion fluid, and such, may be included as part of the kit, or the kit may consist essentially, or entirely, of the blade(s) and device(s).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices and performing any related methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

1. A device to facilitate the installation of a cultivator blade on a shank, comprising:
a frame having a peripheral configuration complementary to a peripheral configuration of the cultivator blade, the frame defining a channel that fits over at least a portion of the edges of the cultivator blade to seat the blade; and
a reinforced tip to provide a striking surface.

2. The device of claim 1 wherein the frame is a substantially V-shaped frame.

3. The device of claim 2 further comprising at least one brace extending between the sides of the V-shaped frame.

4. The device of claim 2 further comprising at least two braces extending between the sides of the V-shaped frame.

5. The device of claim 4 wherein the at least two braces are configured to permit the blade to slide in between the braces of the device to provide support for the blade during installation.

6. The device of claim 1 further comprising a reinforced strike pad integral with or attached to the tip of the device to facilitate ease of urging the blade onto the shank.

7. A method of installing a cultivator blade having a peripheral configuration onto a shank, comprising:
Obtaining a device comprising a frame having a peripheral configuration complementary to the peripheral configuration of the blade, the frame defining a channel that fits over at least a portion of the edges of the cultivator blade to seat the blade and a fortified tip to provide a striking surface;
positioning the blade on the shank;
positioning the device over the blade; and
striking the striking surface of the device.

8. The method of claim 7 wherein one of the cultivator blade and the shank has a hole and the other has a spring-biased detent for attachment of the blade to the shank, and the positioning of the blade on the shank further comprises aligning the hole and the detent to actuate attachment upon striking the striking surface of the device.

9. A cultivator blade and installation kit comprising:
a cultivator blade unattached to a cultivator shank; and
a device to facilitate the installation of the cultivator blade on the shank, comprising:
a frame having a peripheral configuration complementary to a peripheral configuration of the cultivator blade, the frame defining a channel that fits over at least a portion of the edges of the cultivator blade to seat the blade; and
a fortified tip to provide a striking surface.

10. The kit of claim 9 consisting essentially of the blade and the device.
